(19) United States
(12) Patent Application Publication
(10) Pub. No.: US 2016/0339915 A1
(43) Pub. Date: Nov. 24, 2016

(54) VEHICLE CONTROL SYSTEM

(71) Applicant: TOYOTA JIDOSHA KABUSHIKI KAISHA, Toyota-shi (JP)

(72) Inventors: Seiji KUWAHARA, Susono-shi (JP); Kazumi HOSHIYA, Gotemba-shi (JP); Norimi ASAHARA, Numazu-shi (JP); Yoshio ITO, Susono-shi (JP); Takahito ENDO, Nagaizumi-cho (JP); Tadashi FUJIYOSHi, Susono-shi (JP)

(73) Assignee: TOYOTA JIDOSHA KABUSHIKI KAISHA, Toyota-shi (JP)

(21) Appl. No.: 15/138,359

(22) Filed: Apr. 26, 2016

(30) Foreign Application Priority Data
May 18, 2015 (JP) 2015-100881

(51) Int. Cl. B60W 30/18; B60W 10/20; B60W 10/18; G05D 1/00; B60W 10/04

(52) U.S. Cl. CPC B60W 30/18; G05D 1/0088; B60W 10/04; B60W 10/18; B60W 10/20; B60W 2520/10; B60W 2550/308; B60W 2510/18

(57) ABSTRACT

A vehicle control system configured to adjust a vehicle behavior to the behavior expected by the driver in autonomous mode is provided. The vehicle control system determines target values of the driving force, the braking force, and the steering angle based on manual operations of an accelerator, a brake and the steering device in the autonomous mode. A controller corrects a control parameter including a vehicle speed, a distance from a forerunning vehicle, an acceleration and a travelling locus based on the manual operation executed in the autonomous mode.

### CROSS REFERENCE TO RELATED APPLICATIONS

The present invention claims the benefit of priority to Japanese Patent Application No. 2015-100881 filed on May 18, 2015 with the Japanese Patent Office, the entire contents of which are incorporated herein by reference in its entirety.

### BACKGROUND

1. Field of the Invention

Embodiments of the present invention relates to the art of a vehicle control system configured to allow a vehicle to operate autonomously in accordance with a traveling environment without requiring a driver to operate an accelerator, a brake and a steering wheel.

2. Discussion of the Related Art

U.S. Pat. No. 8,260,482 describes an autonomous driving system for vehicles. According to the teachings of U.S. Pat. No. 8,260,482, an operating mode of the automated vehicle is switched from a manual mode to an autonomous mode when a driver rotates a steering wheel or depresses an accelerator pedal or a brake pedal.

In the autonomous mode, target values of driving force and braking force are determined taking account of the travelling environment, a distance from a vehicle running ahead, control parameters such as a vehicle speed, acceleration and so on. According to the conventional art, those parameters are determined in such a manner as to reduce a gap between a vehicle behavior expected by typical drivers and an actual vehicle behavior. Therefore, some drivers may feel a gap between an expected vehicle behavior and an actual vehicle behavior

### SUMMARY

Aspects of embodiments of the present application have been conceived noting the foregoing technical problems, and it is therefore an object of the present application is to provide a vehicle control system configured to adjust a vehicle behavior to the behavior expected by the driver.

The present invention relates to a vehicle control system that is configured to determine a target value of at least one of a driving force, a braking force, and a steering angle to operate a vehicle autonomously without requiring a manual operation, based on a running environment or a running condition and a control parameter including a vehicle speed, a distance from a forerunning vehicle, an acceleration and a travelling locus. In order to achieve the above-explained objective, according to the preferred embodiment, the vehicle control system is provided with a controller that controls the driving force, the braking force, and the steering angle autonomously. Specifically, the controller is configured to: determine the target value based on a manual operation of an accelerator, a brake, or a steering device executed during operating the vehicle autonomously; detect an actual value of at least one of the control parameters such as the vehicle speed, the distance from the forerunning vehicle, the acceleration, and the travelling locus during execution of the manual operation; and correct the control parameter in such a manner as to reduce a difference between the control parameter before execution of the manual operation and a detected value of the control parameter.

Thus, according to the preferred embodiment of the present application, the target value of at least one of the driving force, the braking force, and the steering angle is determined to operate the vehicle autonomously based on the running environment of the vehicle and the predetermined control parameter. In addition, the controller is configured to detect an actual value of at least one of the vehicle speed and the distance from the forerunning vehicle if a manual operation of the accelerator, the brake or the steering device is executed during operating the vehicle autonomously, and to correct the control parameter to reduce a difference between the detected value of the control parameter and the target value of the control parameter before execution of the manual operation. According to the preferred embodiment of the present application, therefore, a gap between a vehicle behavior expected by the driver during operating the vehicle autonomously and an actual vehicle behavior can be reduced.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a flowchart showing a first control example carried out by the control system;

FIG. 2 is a flowchart showing a second control example carried out by the control system;

FIG. 3 is a flowchart showing a third control example carried out by the control system; and

FIG. 4 is a schematic illustration showing the vehicle to which the control system according to the preferred embodiment is applied.

### DETAILED DESCRIPTION OF THE PREFERRED EMBODIMENT(S)

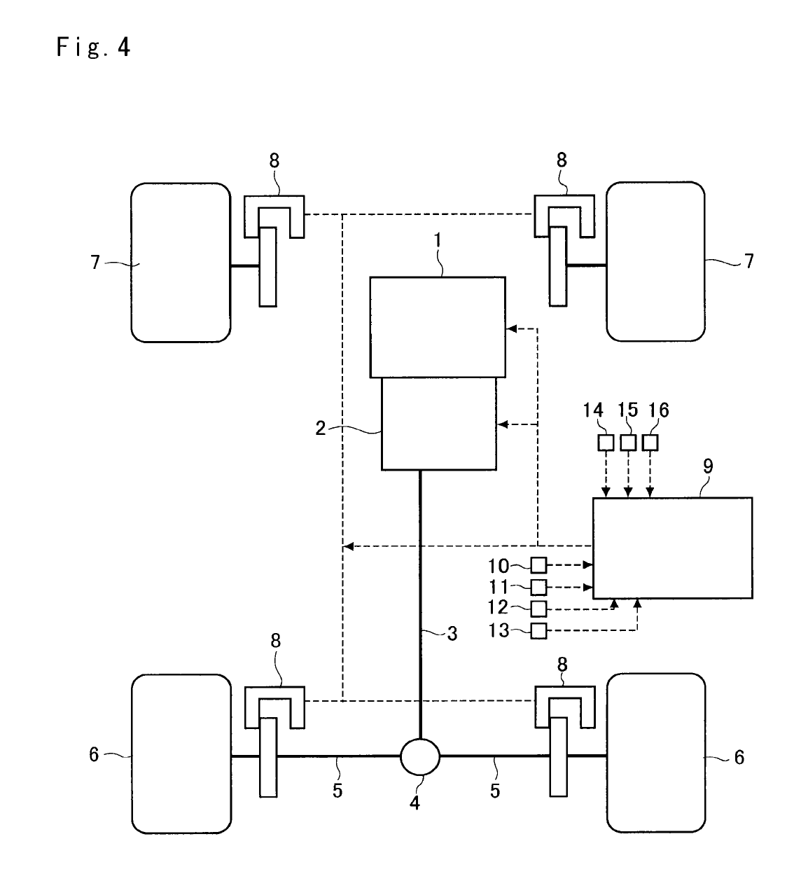

Preferred embodiments of the present application will now be explained with reference to the accompanying drawings. In the vehicle to which the control system according to the preferred embodiment is applied, a driving force, a braking force and a steering angle may be controlled autonomously without requiring manual operations, in accordance with a travelling environment and based on predetermined control parameters. Referring now to FIG. 4, there is shown an example of a front-engine, rear-drive layout vehicle to which the control system according to the preferred embodiment is applied. As illustrated in FIG. 4, the vehicle comprises an engine 1, a transmission 2 connected to the engine 1, and drive wheels 6 connected to the transmission 2 through a propeller shaft 3, a differential gear unit 4 and a driveshaft 5. In the vehicle illustrated in FIG. 4, front wheels 7 are turned to change an orientation of the vehicle, and the front wheels 7 and the drive wheels 6 are individually provided with a brake device 8.

An operating mode of the vehicle can be selected manually by the driver from a manual mode in which the vehicle is operated manually and an autonomous mode in which the vehicle is operated autonomously.

Specifically, in the manual mode, a driving force, a braking force, a steering angle and a speed ratio of the transmission 2 are controlled by manual operations of an accelerator, a brake, a steering wheel, a shift lever etc.

By contrast, in the autonomous mode, a travelling route of the vehicle, a vehicle speed to travel along the travelling route, a transit time on the travelling route and so on are planned based on an existence of both stationary and moving obstacles on the travelling route such as a buildings and housings, pedestrians, cars etc. Then, target values of a driving force, a braking force, a steering angle and so on are determined based on the planned travelling route and the vehicle speed etc., a distance from the forerunning vehicle, control parameters of acceleration, a vehicle speed, a travel locus and a turning radius of the vehicle during turning and so on. During propulsion in the autonomous mode, therefore, the driving force, the braking force, the steering angle and so on are controlled based on the target values thereof thus determined. Here, it is to be noted that initial values of those control parameters are determined in such a manner as to reduce a gap between a vehicle behavior expected by typical drivers and an actual vehicle behavior.

Specifically, the operating mode of the vehicle is switched between the autonomous mode and the manual mode by a manual operation of a switch executed by the driver. If the accelerator pedal, the brake pedal or the steering wheel is operated manually by the driver during propulsion in the autonomous mode, the driving force, the braking force or the steering angle is controlled based on such manual operation executed by the driver while maintaining the autonomous mode, as long as such manual operation is continued. For example, if the accelerator pedal is depressed during propulsion in the autonomous mode, the driving force is controlled in accordance with a depression of the accelerator pedal. In this situation, if the steering wheel is not rotated by the driver, the steering angle is controlled based on the target value determined to propel the vehicle in the autonomous mode. That is, an intension of the driver may be reflected on the autonomous operation. In the autonomous mode, the above-explained control parameters are continuously detected during continuance of such manual operation executed by the driver, and the vehicle is completely brought into the autonomous mode upon termination of such manual operation.

In order to control the driving force, the braking force and the steering angle, the vehicle is provided with an electronic control unit (to be abbreviated as the “ECU” hereinafter) 9 as a controller composed mainly of a microcomputer. To this end, detection signals and information from the following devices are sent to the ECU 12, such as an accelerator sensor 10 for detecting a depression of the accelerator pedal or an opening degree of an accelerator, a brake sensor 11 for detecting a depression of the brake pedal, a steering sensor 12 for detecting a steering angle of the steering wheel, a shift lever sensor 13 for detecting a position of the shift lever, a vehicle speed sensor 14 for detecting a wheel speed of the vehicle, an external condition sensor 15 for detecting an external condition of the vehicle such as a distance from the forerunning vehicle and existence of vehicles and pedestrians around the vehicle, a switch 16 for switching the operating mode and so on. The ECU 12 is configured to carry out calculations based on the incident data or information and preinstalled data, and calculation results are sent in the form of command signal to the engine 1, the brake 8, the transmission 2, an actuator of the steering device for turning the front wheels 7 etc.

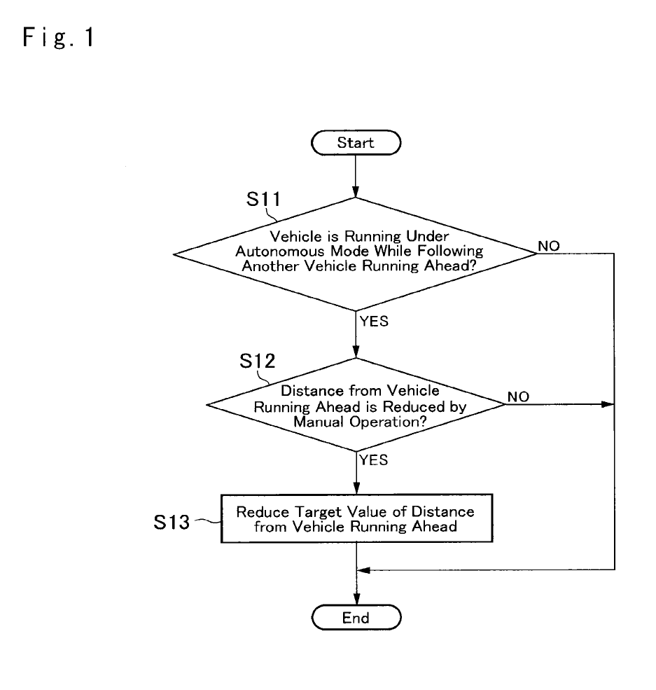

The above-explained manual operation is supposed to be executed by the driver if the actual vehicle behavior in the autonomous mode is different from the expected behavior. The vehicle control system according to the preferred embodiment is configured to correct the control parameters to operate the vehicle autonomously based on the manual operation executed during propulsion in the autonomous mode. Turning now to FIG. 1, there is shown a first control example according to the preferred embodiment, and the routine shown therein is repeated at a predetermined interval. According to the first control example, first of all, it is determined at step S11 whether or not the vehicle is following a vehicle running ahead in the autonomous mode. Specifically, such determination of the current operating mode can be made based on a signal from the switch 16 for selecting the operating mode, or by determining whether or not a flag representing the autonomous mode is erected. Meanwhile, such determination of the fact that the vehicle is following the vehicle running ahead can be made based on a fact that the driving force and the braking force are controlled in such a manner as to keep a predetermined target distance from the forerunning vehicle. That is, the distance from the vehicle running ahead is used as a control parameter to operate the vehicle autonomously, and the driving force and the braking force is controlled to keep the target distance from the vehicle running ahead.

If the vehicle is currently propelled in the manual mode, or if the vehicle is currently propelled in the autonomous mode but not following another vehicle so that the answer of step S11 is NO, the routine is terminated without carrying out any specific control. By contrast, if the vehicle is following a vehicle running ahead in the autonomous mode so that the answer of step S11 is YES, the routine progresses to step S12 to determine whether or not the distance from the vehicle running ahead is reduced by a manual operation of the accelerator executed by the driver. As described, during following the vehicle running ahead in the autonomous mode, the driving force and the braking force are controlled in such a manner as to keep the target distance from the forerunning vehicle. At step S12, therefore, such determination can be made by determining whether or not the current distance from the vehicle running ahead detected by the external condition sensor 15 is reduced to be shorter than the target distance by a manual operation of the accelerator. If the manual operation of the accelerator is not executed so that the answer of step S12 is NO, the routine is terminated without carrying out any specific control.

By contrast, if the distance from the vehicle running ahead is reduced to be shorter than the target distance by the manual operation of the accelerator so that the answer of step S12 is YES, the target distance from the vehicle running ahead is corrected or updated at step S13 based on the current distance from the vehicle running ahead, and then the routine is terminated. Specifically, the target distance from the forerunning vehicle that is set prior to the execution of the manual operation of the accelerator is reduced toward the current distance from the forerunning vehicle to the extent that the vehicle will not collide with the forerunning vehicle even if the forerunning vehicle stops suddenly.

Thus, according to the first control example, the distance from the vehicle running ahead is used as the control parameter to propel the vehicle in the autonomous mode, and the target value of the control parameter is corrected or updated to reduce a difference between the target value before the execution of the manual operation and the target value after the execution of the manual operation. According to the first control example, therefore, a gap between a vehicle behavior expected by the driver and an actual vehicle behavior can be reduced on the next opportunity to propel the vehicle in the autonomous mode while following another vehicle running ahead.

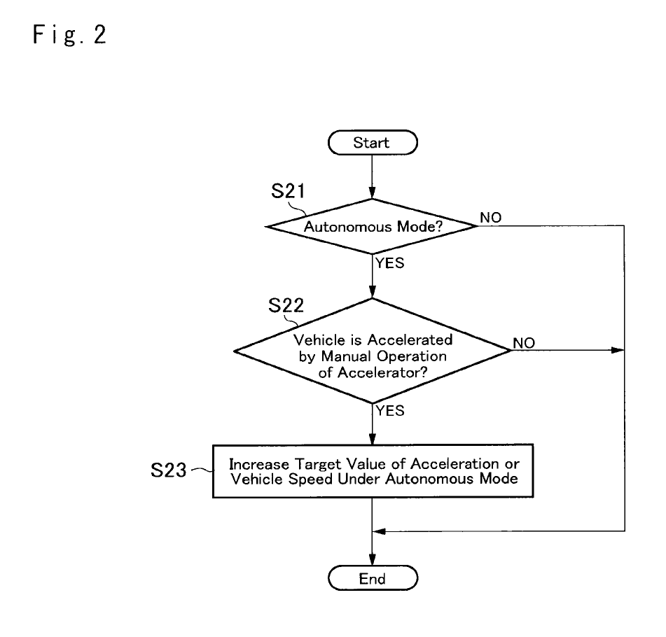

Turning to FIG. 2, there is shown a second control example according to the preferred embodiment, and the routine shown therein is also repeated at a predetermined interval. According to the second control example, first of all, it is determined at step S21 whether or not the vehicle is propelled in the autonomous mode. Specifically, such determination of the current operating mode may also be made based on a signal from the switch 16, or by determining whether or not the flag representing the autonomous mode is erected. If the vehicle is currently propelled in the manual mode so that the answer of step S21 is NO, the routine is terminated without carrying out any specific control.

By contrast, if the vehicle is propelled in the autonomous mode so that the answer of step S21 is YES, the routine progresses to step S22 to determine whether or not the vehicle is accelerated by a manual operation of the accelerator executed by the driver. Such determination can be made based on signals from the accelerator sensor 10 and the vehicle speed sensor 14. If the vehicle is not accelerated by the manual operation of the accelerator, or if the accelerator is operated by the driver but the vehicle is not accelerated so that the answer of step S22 is NO, the routine is terminated without carrying out any specific control.

By contrast, if the vehicle is accelerated by the manual operation of the accelerator so that the answer of step S22 is YES, this means that the driver has a desire to accelerate the vehicle or to increase the vehicle speed. In this case, therefore, the routine progresses to step S23 to correct or update a target value of acceleration or vehicle speed to operate the vehicle autonomously based on an operating amount of the accelerator or an actual acceleration during execution of the operation of the accelerator, in such a manner as to achieve the acceleration or the vehicle speed demanded by the driver. In this case, the target value of acceleration may be increased to the extent without causing a tire slippage, and the vehicle speed may be increased within a legal speed limit.

Thus, according to the second control example, the acceleration is used as the control parameter to propel the vehicle in the autonomous mode, and the target value of the acceleration is corrected or updated to reduce a difference between the target value before the execution of the manual operation and the target value after the execution of the manual operation. According to the second control example, therefore, a gap between a vehicle behavior expected by the driver and an actual vehicle behavior may also be reduced on the next opportunity to propel the vehicle in the autonomous mode.

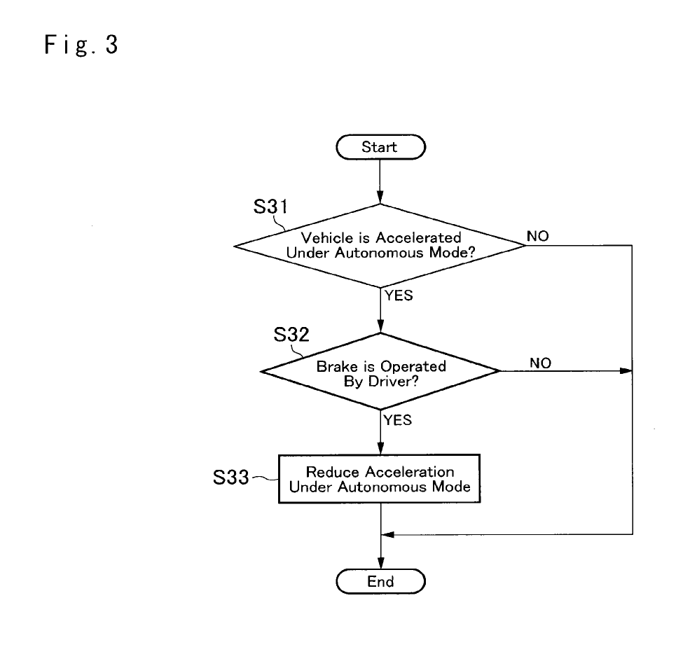

Turning to FIG. 3, there is shown a third control example to moderate acceleration during propulsion in the autonomous mode based on a manual operation of the brake, and the routine shown therein is also repeated at a predetermined interval. According to the third control example, first of all, it is determined at step S31 whether or not the vehicle is being accelerated in the autonomous mode. As the foregoing steps S11 and S21, such determination of the operating mode may also be made based on a signal from the switch 16, or by determining whether or not the flag representing the autonomous mode is erected. Meanwhile, an increase in the acceleration may be determined based on control amounts of an output torque of the engine 1 and a speed ratio of the transmission 2 to operate the vehicle autonomously, and a running resistance such as a road load. Alternatively, an increase in the acceleration may also be determined based on a change rate of vehicle speed.

If the vehicle is currently propelled in the manual mode, or if the vehicle is currently propelled in the autonomous mode but not being accelerated so that the answer of step S31 is NO, the routine is terminated without carrying out any specific control. By contrast, if the vehicle is being accelerated in the autonomous mode so that the answer of step S31 is YES, the routine progresses to step S32 to determine whether or not the brake is operated manually by the driver. That is, at step S32, it is determined whether or not the driver has a desire to moderate the acceleration of the vehicle, and such determination can be made based on a signal from the brake sensor 11. If the brake is not operated by the driver so that the answer of step S32 is NO, the routine is terminated without carrying out any specific control.

By contrast, if the brake is operated by the driver so that the answer of step S32 is YES, the routine progresses to step S33 to correct or update a target value of acceleration or driving force to operate the vehicle autonomously based on an operating amount of the brake, and the routine is terminated. Consequently, the target value of acceleration is reduced from that before the execution of the manual operation of the brake.

Thus, according to the third control example, the acceleration is also used as the control parameter to propel the vehicle in the autonomous mode, and the target value of the acceleration may also be corrected or updated to reduce a difference between the target value before the execution of the manual operation and the target value after the execution of the manual operation. According to the third control example, therefore, a gap between a vehicle behavior expected by the driver and an actual vehicle behavior may also be reduced on the next opportunity to propel the vehicle in the autonomous mode.

Although the above exemplary embodiments of the present application have been described, it will be understood by those skilled in the art that the present application should not be limited to the described exemplary embodiments, and various changes and modifications can be made within the spirit and scope of the present application. For example, if the accelerator is operated manually by the driver during accelerating the vehicle in the autonomous mode, this means that the driver has a desire to operate the vehicle in a sporty manner. In this case, therefore, the target value of acceleration or driving force may be increased. If the steering angle or a depression of the accelerator opening is increased manually during turning, this also means that the driver has a desire to operate the vehicle in a sporty manner. In this case, therefore, a target value of lateral acceleration or yaw rate may be increased to increase a vehicle speed during turning and to reduce a turning radius. By contrast, if the brake pedal is depressed or a downshifting is executed manually during following the forerunning vehicle, this means that the driver has a desire to increase a distance from the forerunning vehicle. In this case, therefore, the target value of the distance from the forerunning vehicle may be increased.

In addition, the vehicle control system according to the preferred embodiment may also be applied to a front-engine, front-drive layout vehicle. The vehicle control system according to the preferred embodiment may also be applied to a hybrid vehicle in which a prime mover includes an engine and a motor, and to an electric vehicle in which a motor is used as a prime mover instead of the engine. Further, not only a geared transmission but also a continuously variable transmission may be used as the above-explained transmission.

What is claimed is:

1. A vehicle control system that is configured to determine a target value of at least one of a driving force, a braking force, and a steering angle to operate a vehicle autonomously without requiring a manual operation, based on a running environment or a running condition and a control parameter including a vehicle speed, a distance from a forerunning vehicle, an acceleration and a travelling locus, comprising:
a controller that controls the driving force, the braking force, and the steering angle autonomously;
wherein the controller is configured
to determine the target value based on a manual operation of an accelerator, a brake, or a steering device executed during operating the vehicle autonomously,
to detect an actual value of at least one of the control parameters such as the vehicle speed, the distance from the forerunning vehicle, the acceleration, and the travelling locus during execution of the manual operation, and
to correct the control parameter in such a manner as to reduce a difference between the control parameter before execution of the manual operation and a detected value of the control parameter.

2. The vehicle control system as claimed in claim 1, further comprising:
a sensor that detects at least one of the vehicle speed, the distance from the forerunning vehicle, the acceleration and the travelling locus, and
wherein the controller is further configured to correct a target value of the control parameter in such a manner as to reduce a difference between the target value of the control parameter and a value of the control parameter detected by the sensor during execution of the manual operation.

3. The vehicle control system as claimed in claim 2,
wherein the sensor includes a distance sensor for detecting a distance from the forerunning vehicle, and
wherein the controller is further configured
to determine a fact that the vehicle is following a vehicle running ahead in the autonomous mode,
to detect the distance from the vehicle running ahead by the distance sensor during execution of the manual operation, and
to reduce a target value of the distance from the vehicle running ahead in the autonomous mode if the distance from the vehicle running ahead is reduced by the manual operation.

4. The vehicle control system as claimed in claim 2,
wherein the sensor includes a vehicle speed sensor, an acceleration sensor and an accelerator sensor, and
wherein the controller is further configured
to detect a manual operation of an accelerator by the accelerator sensor in the autonomous mode,
to detect acceleration of the vehicle by the acceleration sensor if the vehicle speed detected by the vehicle speed sensor is increased by the manual operation of the accelerator, and
to increase the target value of the acceleration in the autonomous mode in such a manner as to reduce a difference between the target value of the acceleration and the acceleration detected by the acceleration sensor during execution of the manual operation, or to increase the target value of the vehicle speed in the autonomous mode in such a manner as to reduce a difference between the target value of the vehicle speed and the vehicle speed detected by the vehicle speed sensor during execution of the manual operation.

5. The vehicle control system as claimed in claim 2,
wherein the sensor includes a brake sensor that detects a depression of a brake pedal, and
wherein the controller is further configured to reduce the target value of the acceleration in the autonomous mode based on the depression of the brake pedal detected by the brake sensor if the brake sensor detects a fact that the brake pedal is depressed during accelerating the vehicle in the autonomous mode.
